(19) United States
(12) Patent Application Publication
(10) Pub. No.: US 2012/0052329 A1
(43) Pub. Date: Mar. 1, 2012

(54) SELF-ASSEMBLED MONOLAYER

(75) Inventors: Kaizhong Gao, Eden Prairie, MN (US); Leping Li, Bloomington, MN (US); Richard M. Fuller, Minneapolis, MN (US)

(73) Assignee: SEAGATE TECHNOLOGY LLC, Scotts Valley, CA (US)

(21) Appl. No.: 12/871,623

(22) Filed: Aug. 30, 2010

(51) Int. Cl. G11B 5/66; G11B 5/85; G11B 5/84

(52) U.S. Cl. 428/827; 428/831; 428/832; 427/127

(57) ABSTRACT

A magnetic recording composite comprises a substrate, a plurality of layers deposited over the substrate, the plurality of layers defining an outer surface, and a self-assembled monolayer deposited over the outer surface of the plurality of layers. The self-assembled monolayer has an outer surface and comprises a plurality of molecules each having a head group bonded to the outer surface of the plurality of layers, a body group, and a tail group. The tail groups of the plurality of molecules form the outer surface of the self-assembled monolayer, and the self-assembled monolayer forms a substantially continuous layer over the outer surface of the magnetic recording layer.

### FIELD OF THE INVENTION

The present disclosure relates generally to protection or lubrication of devices, such as magnetic recording devices, including magnetic recording heads of magnetic recording devices.

### BACKGROUND

In a disc drive storage system, the discs are mounted on a spindle and the discs are rotated at high speeds. The high speed rotation causes the magnetic recording heads to float on a fast moving thin layer of air above the surface of the disc. The surface containing the read/write recording heads that are in contact with this cushion of air is typically referred to as an air bearing surface (ABS).

The ABS and the disc may comprise a protective layer of carbon to prevent the underlying surface from mechanical damage, contamination, and corrosion. When applied to the recording heads, an adhesion layer may be included. When applied to the disc, the carbon overcoat may be applied directly to the disc and a layer of lubricant may be applied over the carbon overcoat.

### SUMMARY OF THE INVENTION

In one example, the disclosure is directed a magnetic recording composite comprises a substrate, a plurality of layers deposited over the substrate, the plurality of layers defining an outer surface, and a self-assembled monolayer deposited over the outer surface of the plurality of layers. The self-assembled monolayer has an outer surface and comprises a plurality of molecules each having a head group bonded to the outer surface of the plurality of layers, a body group, and a tail group. The tail groups of the plurality of molecules form the outer surface of the self-assembled monolayer, and the self-assembled monolayer forms a substantially continuous layer over the outer surface of the magnetic recording layer

### BRIEF DESCRIPTION OF DRAWINGS

FIG. 1 is a schematic side-view diagram of an example magnetic storage composite.

FIG. 2 is an elevation view of an example disc drive storage system.

FIG. 3 is a schematic side view of an example magnetic recording composite protected by a first example of a self-assembled monolayer and an example read/write head protected by a second example of a self-assembled monolayer

FIG. 4 is a representation of an example precursor molecule used to make an example self-assembled monolayer.

FIG. 5 is a schematic side view of an example magnetic recording composite comprising a plurality of binding sites protected by another example self-assembled monolayer.

FIG. 6 is a graph of a Fourier transform infra-red (“FTIR”) spectrum analysis of a self-assembled monolayer made from the example precursor molecule of FIG. 4.

### DETAILED DESCRIPTION

In general, the present disclosure relates to magnetic storage composites and magnetic read/write heads that may be used in magnetic data storage systems, such as, e.g., hard disc drives. The magnetic storage composite and/or read/write heads may include a protective layer and/or a lubricating layer at its outer surface.

In some examples, the disclosure relates to a magnetic storage composite including a self-assembled monolayer that may be formed over a magnetic recording layer. In general, “self-assembled monolayer,” as used herein, refers to a layer comprising a plurality of molecules each having a head group, a body group, and a tail group, wherein the head group may show a special affinity for a material onto which the self-assembled monolayer will be deposited. The layer may be considered “self-assembled” because the molecules that form the layer may organize on their own, such as by the bonding of the head groups to the surface and the chemical interaction between neighboring body groups and tail groups. The layer may be considered a “monolayer” because, in general, the layer comprises a single layer of the molecules. The head groups of the plurality of molecules bond to the outer surface of the magnetic composite while the body groups pack tightly together to form a generally uniform layer with the tail groups forming an outer surface of the self-assembled monolayer. Depending on the particular structure of the self-assembled monolayer and the chemical makeup of the head groups, body groups, and tail groups, the self-assembled monolayer may provide for protection or lubrication of magnetic recording composite or magnetic read/write heads of magnetic recording systems.

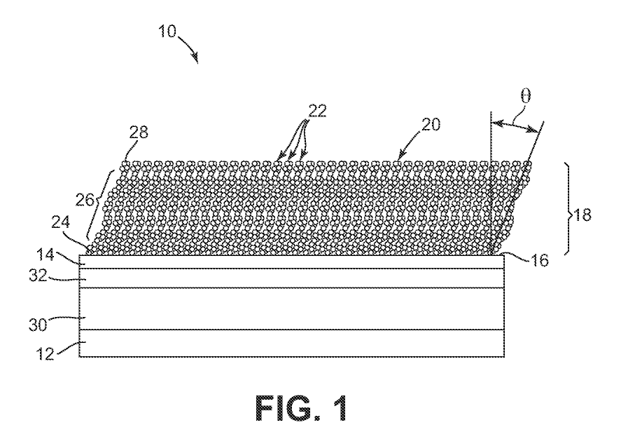

FIG. 1 is a schematic diagram illustrating a magnetic recording composite 10 that comprises a plurality of layers deposited over a substrate 12. The plurality of layers defines an outer surface 16, and a self-assembled monolayer (“SAM”) is deposited over outer surface 16. In one example, the plurality of layers deposited over substrate 12 comprises a magnetic recording layer 14 deposited over substrate 12, wherein magnetic recording layer 14 comprises outer surface 16. SAM 18 comprises an outer surface 20 and a plurality of molecules 22 each having a head group 24 bonded to outer surface 16 of magnetic recording layer 14, a body group 26, and a tail group 28, wherein the tail groups 28 of the plurality of molecules 22 form outer surface 20 of SAM 18, and wherein SAM 18 forms a substantially continuous layer over outer surface 16 of magnetic recording layer 14.

Substrate 12 may include any known substrate used in magnetic recording media. In some examples, substrate 12 may be comprised of a suitable glass, ceramic, glass-ceramic, polymeric material, a non-magnetic metal, such as aluminum, or a non-magnetic metal alloy, such as an aluminum-alloy, such as Al—Mg having a NiP plating layer on the deposition surface thereof, or a composite or laminate of these materials.

Magnetic recording layer 14 is deposited over substrate 12 and may include any known material used for magnetic storage in magnetic recording composites. For example, magnetic recording layer 14 may be a magnetic material with a high coercivity so that the particles in recording layer 40 are unlikely to spontaneously reverse their magnetic orientation due to the superparamagnetic effect. Suitable materials for magnetic recording layer 14 may include cobalt-based alloys, such as Co—Cr, Co—Pt, Co—B, Co—Nb, Co—W, and Co—Ta alloys. These alloys can include alloys having other components. For example, a CoCr alloy can also include platinum (CoCrPt) and the CoCrPt alloy can include other elements such as boron (CoCrPtB). In addition, the magnetic recording layer can comprise an oxide, such as a CoCrPt-oxide or a CoCrPtB-oxide. Such oxides can further include silicon (Si), such as a CoCrPtSi-oxide or a CoCrPtBSi-oxide. Suitable materials for energy-assisted magnetic recording (“EAMR”), such as heat-assisted magnetic recording (“HAMR”) or thermally-assisted magnetic recording (“TAMR”), may also include other high anisotropy alloys, such as FePt based granular, composite, or multilayer alloys which may include other components such as B, Cu, Au, Ti, Ta, Rh, or oxides thereof. Recording layer 14 is relatively thin, and in one example has a thickness of between about 3 nanometers (nm) and about 20 nm, such as between about 8 nm and about 18 nm. In addition, although FIG. 1 is shown with a single magnetic recording layer 14, multiple recording layers may be used.

Magnetic recording composite 10 may include one or more layers between substrate 12 and magnetic recording layer 14. For example, magnetic recording composite 10 could include several intermediate layers (not shown), including an adhesive layer to promote adhesion between substrate 12 and an adjacent layer, and one or more seed layers (now shown). In another example, a non-magnetic metallic layer may be included between magnetic recording layer 14 and substrate 12 in order to enhance energy coupling efficiency. If magnetic recording composite 10 is configured for perpendicular magnetic recording, it may include one or more soft underlayers 30, i.e. a layer made from a soft magnetic material including Ni, NiFe (Permalloy), Co, CoZr, CoZrCr, CoZrNb, CoFe, Fe, FeN, FeSiAl, FeSiAlN, CoNiFe, CoFeB, and CoNiFeB, one or more relatively thin non-magnetic interlayers 32 to prevent magnetic interaction between the soft underlayer 30 and recording layer 14 and to promote microstructural and magnetic properties of recording layer 14. Finally, there can be one or more layers between the magnetic recording layer 14 and a SAM 18 deposited over magnetic recording layer 14, including a protective overcoat (not shown) such as one made from diamond-like carbon.

In one example, SAM 18 protects one or more surfaces within a magnetic disc drive storage system from mechanical damage due to mechanical scratching, surface contamination from unwanted materials, and corrosion due to chemical attack. In one example, magnetic recording composite 10 comprises a storage disk for a hard disk drive magnetic storage device.

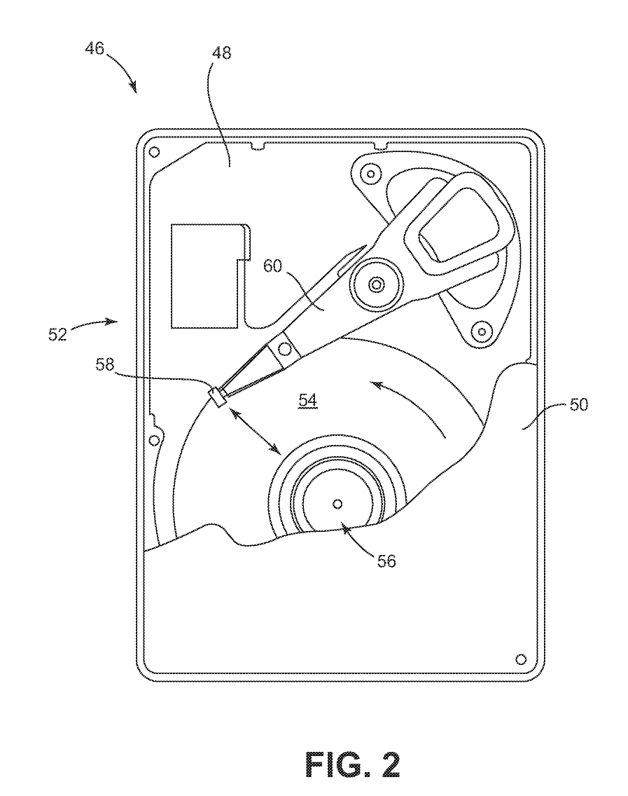

FIG. 2 depicts a magnetic hard disc drive 46 that comprises a base 48 and top cover 50, shown partially cut away in FIG. 2. Base 48 combines with top cover 50 to form the housing 52 of disc drive 46. Disc drive 46 also includes one or more magnetic storage members that include a magnetic storage composite, which in FIG. 2 are one or more rotatable magnetic data discs 54 that include a magnetic storage composite. Data discs 54 are attached to spindle 56, which operates to rotate discs 54 about a central axis. Magnetic read/write head 58 is adjacent to data discs 54. Actuator arm 60 carries magnetic read/write head 58 for communication with each of the data discs 54. Magnetic read/write head 58 writes data to data discs 54 by generating magnetic fields sufficient to magnetize bit domains of the magnetic storage composite of data discs 54. Magnetic read/write head 58 reads data from data discs 54 by detecting the magnetic fields of the bit domains of magnetic recording composite 10.

As shown in FIG. 1, and described above, a SAM 18 is deposited over an outer surface 16 of magnetic recording layer 14. The term “deposited over” as it is used in this application means that a particular layer is placed over another layer, but not necessarily directly over the other layer. For example, although SAM 18 is shown deposited directly onto magnetic recording layer 14, one or more layers may be interposed between magnetic recording layer 14 and SAM 18, including a protective overcoat (not shown) such as one made from diamond-like carbon. In such a case, SAM 18 would still be considered “deposited over” magnetic recording layer 14. Similarly, magnetic recording layer 14 is “deposited” over substrate 12 even though layers 30 and 32 are shown interposed between them.

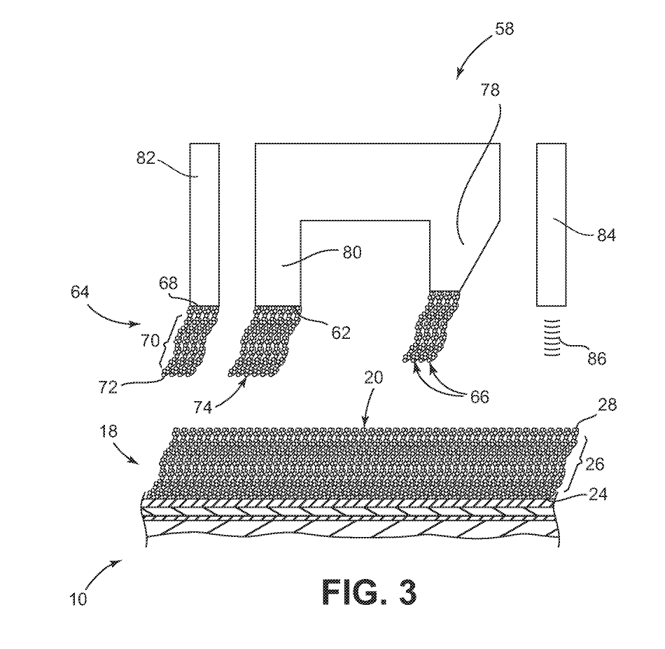

Read/write head 58 flies over magnetic recording composite 10 along a thin layer of air. An air bearing surface (ABS) 62 of read/write head 58 (shown in FIG. 3) opposes outer surface 16 of recording composite 10 and outer surface 20 of SAM 18 and rides along the air layer so that read/write head 58 remains spaced from outer surface to avoid mechanical damage to read/write head 58 or recording composite 10. A read head (not shown) may also be included. FIG. 3 shows recording composite 10 configured for perpendicular recording, wherein the magnetic grains within magnetic recording layer 14 are oriented generally perpendicular to magnetic recording layer surface 16 and magnetic recording layer 10 further comprises a soft underlayer 30 (FIG. 1) that focuses the magnetic flux produced by read/write head 58 to produce a stronger write field gradient.

SAM 18 comprises a plurality of molecules 22 each having a head group 24 bonded to outer surface 16 of magnetic recording layer 14, a body group 26, and a tail group 28. SAM 18 forms a substantially continuous layer over outer surface 16 of magnetic recording layer 14 such that the tail groups 28 of the plurality of molecules 22 form an outer surface 20 of SAM 18.

Molecules 22, and particularly head group 24, body group 26, and tail group 28 of molecules 22, are selected to create a SAM 18 with particular properties and performance characteristics. For example, head group 24 can be selected to ensure a strong chemical bond to the material of magnetic recording layer 14, while body group 26 and tail group 28 can be selected to tailor SAM 18 for enhanced electrical, optical, mechanical, thermal, and chemical performance, such as thermal resistance to high temperatures associated with EAMR, mechanical resistance to wear of magnetic recording layer 14, or resistance to corrosion of magnetic recording layer 14 or other materials of magnetic recording composite 10.

Head group 24 bonds with an outer surface of magnetic recording layer 14. Head group 24 may be selected to form a strong chemical bond with the material of magnetic recording layer outer surface 16. The chemical properties of head group 24 depend greatly on the material to which it is bonded. Generally speaking, however, head group 24 is expected to be bonded with a metal or metal alloy component of magnetic recording layer 14, and as such, in one example, head group 24 is a polar head group that will form a strong chemical bond with outer surface 16. Examples of polar head groups 24 that can be bonded to metal and metal alloy components include fluoroalkyl groups, halogenated alkyl groups, and thiol groups, such as the thiol group of a perfluorohexadecanethiol molecule.

Body group 26 extends between head group 24 and tail group 28 and provides the bulk of molecule 22. In one example, body group 26 is selected to provide particular physical and chemical properties of SAM 18, most notably to provide a predetermined thickness, density, hardness, stability at high temperatures, chemical inertness, low surface tension, and corrosion resistance of SAM 18. In one example, body group 26 is a chain-like backbone made of carbon and fluorine molecules, simple alkyl backbone group, or other alkyl group with substituted conjugated or aromatic components. Examples of suitable body groups 26 include fluoroalkyl backbones having between 2 and 20 carbon atoms, such as between 3 and 15 carbon atoms, for example between 4 and 10 carbon atoms, substituted alkyl backbones, such as chlorinated or fluorinated alkyl backbone chains, having between 2 and 20 carbon atoms, such as between 3 and 15 carbon atoms, for example between 4 and 10 carbons atoms. In one example, body group 26 is selected so that molecules 22 form a highly ordered assembly when bonded to outer surface 16, as shown in FIGS. 1 and 3. In particular, Van der Waals forces and other intermolecular forces can cause molecules 22 to pack together very tightly to prevent corrosive agents or surface contaminants, such as those associated with ozone attack or oxygen ash, from reaching magnetic recording composite outer surface 16. A tightly-packed SAM 18 can also prevent another component from touching outer surface 16 and causing damage via a mechanical scratch. In one example, body group 26 comprises a fluoroalkyl backbone that provides for corrosion resistance, resistance to oxidize agents, and resistance to surface contaminants, such as those associated with ozone attack or oxygen ash. A fluroalkyl backbone may also prevent these harmful agents from reaching magnetic recording composite outer surface 16. In addition, SAM 18 formed by SAM molecules 22 comprising a body group 26 of a fluorocarbon backbone has a high lubricity due to its extremely low surface tension which prevents another component from sticking on the outer surface 16 and causing damage via a mechanical scratch. In one example, body group 26 is selected so that SAM molecules 22 orient themselves at an angle A between each molecule 22 and the normal of outer surface 16, as shown in FIG. 1. Angle θ, along with the length and composition of body group 26 directly affect the thickness and density of SAM 18. In one example, angle θ is between about 0 degrees and about 45 degrees, such as between about 5 degrees and about 30 degrees, for example about 30 degrees.

Functional tail group 28 provides an outer surface 20 of SAM 18 and is the only part of SAM 18 that is “seen” from the exterior of SAM 18 if the SAM is closely packed on the surface. In one example, tail group 28 is configured to exhibit predetermined surface properties, such as hydrophobicity, hydrophilicity, lipophobicity, and repulsion of oxygen. In one example, tail groups 28 are both hydrophobic and lipophobic so that both polar and non-polar group will not stick to outer surface 20 of SAM 18, in particular so that neither water nor oil or oil-like materials will stick to outer surface 20. Hydrophobicity and lipophobicity may be accomplished with a fluroalkyl backbone molecule 20, such as a backbone having the general formula of —(CF₂)ₙ—CF₃. Tail group 28 may also be configured to bond with the material of another layer, such as a lubricant layer deposited over SAM 18. Examples of tail groups 28 that are hydrophobic include alkyl end groups such as methyl, chlorinated methyl groups (i.e. trichloromethyl), and fluorinated methyl groups (i.e. trifluoromethyl). Examples of hydrophilic tail groups 28 include hydroxyl groups, carboxyl groups, sulfuric group, sulfonate groups, and primary, secondary, and tertiary amines.

FIG. 3 shows another example with a second self-assembled monolayer (SAM) 64 deposited over an air-bearing surface (“ABS”) 62 of read/write head 58. Similar to recording composite SAM 18, the molecules 66 of read/write head SAM 64 comprises a head group 68, a body group 70, and a tail group 72. Head group 68 bonds with ABS 62, body group 70 extends between head group 68 and tail group 72, and tail group 72 provides an outer surface 74 of SAM 64. In one example, a hard disc assembly is a device that includes magnetic recording composite 10 comprising magnetic recording layer 14 deposited over substrate 12 and a first SAM 18 having a first outer surface 20 deposited over magnetic recording layer 14, and a read/write head 58 having a surface 62 opposing first outer surface 20, wherein first SAM 18 comprises a plurality of first molecules 22 each having a first head group 24 bonded to magnetic recording layer 14, a first body group 26, and a first tail group 28, wherein the first tail groups 28 form outer surface 20 of first SAM 18, wherein the first SAM 18 forms a substantially continuous layer over magnetic recording layer 14, and wherein read/write head 58 comprises a second SAM 64 deposited over the surface 62 opposing first outer surface 20 of first SAM 18, the second SAM 64 comprising a plurality of second molecules 66 each having a second head group 68 bonded to the read/write head surface 62, a second body group 70, and a second tail group 72.

As with SAM 18 deposited over magnetic recording composite 10, described with respect to FIG. 1, SAM 64 may replace a protective layer over read/write head 58, such as a DLC overcoat. In this case, because head groups 68 of SAM 64 are customized to form a chemical bond with the material of ABS 62, SAM 64 has no adhesion layer, as is used with a DLC overcoat. In one example, body groups 26, 70 and tail groups 28, 72 of magnetic recording layer SAM 18 and read/write head SAM 64 are configured to be substantially the same or chemically similar to avoid one SAM 18, 64 from dominating and/or abrading the other. As with SAM 18, described above, SAM 64 may provide for both protection and lubrication when body group 70 and tail group 72 of SAM 64 provide for an outer surface 74 having low surface tension so that most contaminants will not be able to stick onto surface 74, or if they do stick, can be easily removed or dusted off. In addition, body group 70 and tail group 72 may have a high heat and chemical resistance. The low surface tension also increases the contact angle, so corrosive chemicals, contaminants, or particles will not stick to SAM surface 74. In one example, body group 26 and head group 28 comprise a backbone having the general formula of —(CF₂)ₙ—CF₃, wherein n is between about 2 and about 20, such as between about 4 and about 15, for example between about 4 and about 10. SAM 64 may also replace a lubricant when body groups 70 provide for a low surface tension in order to reduce the contact area to a minimum. In one example, a fluorocarbon backbone having the general formula of —(CF₂)ₙ—CF₃ described above provides for this low surface tension. Finally, SAM 64 may provide the protection that is typically provided by a protective layer, such as a DLC overcoat, body groups 70 and head groups 72 may provide for resistance to high temperatures and chemical stability.

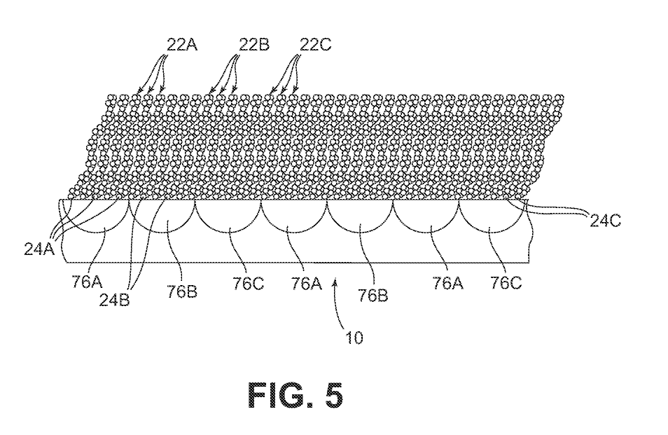

In some examples, the materials that head groups of the self assembled monolayer will have to bond to may vary within the same disc drive 46. For example, in the example shown in FIG. 5, magnetic recording composite 10 comprises a plurality of binding sites 76A, 76B, 76C, wherein a first binding site 76A comprises a first material and a second binding site 76B comprises a second material. A third binding site 76C may comprise a material that is different than the materials in both binding sites 76A and 76B, or the material of binding site 76C may be the same as one of the other two binding sites 76A and 76B. The plurality of molecules 22 that form SAM 18 can comprise a plurality of first molecules 22A having a first head group 24A that bonds to the first material of first binding site 76A and a plurality of second molecules 22B having a second head group 24B that bonds to the second material of the second binding site 76B. If the material of third binding site 76C is a different material than that in binding sites 76A, 76B, then a plurality of third molecules 22C having a third head group 24C that bonds to the third material of the third binding site 76C may be used. The multiple materials at different binding sites of magnetic recording composite 10 may occur if magnetic recording layer 14 is made from a magnetic alloy, such as a FePt or CoCrPt alloy, with different metal atoms at each binding site 76A, 76B, 76C. For example, if magnetic recording layer 14 is a CoCrPt allow, first binding site 76A may comprise cobalt atoms, second binding site 76B may comprise chromium atoms, and third binding site 76C may comprise platinum atoms. Multiple types of SAM molecules 22A, 22B, 22C can be chosen with head groups 24A, 24B, 24C that selectively bind to the material of each binding site 76A, 76B, 76C to form a uniform SAM 18.

In another example, ABS 62 of read/write head 58 is made up of the air bearing surfaces of several portions of read/write head 58, such as a write pole 78, a shield pole 80, and a shield 82. As such, ABS 62 can comprise multiple materials at various points along ABS 62. For example, write pole 78 may be made of a CoFe alloy and shield pole 80 may be made of a CoNiFe alloy. Similarly, the air bearing surface of the read pole (not shown) can be made from CoNiFe or CoFe alloy. Several other components of read/write head 58 or actuator arm 60 may also present an air bearing surface that could come into contact with recording composite 10 such that it is able to form a SAM 64 that can protect or lubricate possible air bearing surfaces. Examples of additional components that may present air bearing surfaces to be protected by SAM 64 include a reader (also referred to as a read head), a reader shield, a write head shield, a contact pad, a write pole, a write coil, an optical near field transducer (NFT), an optical waveguide core, and cladding. Materials that may be used to construct the read head, actuator arm, and other components that may present air bearing surfaces include CoFe, NiFe, CoNiFe, Ru, Au, Cu, Rh, W, and their alloys, and TaO, Al₂O₃, and Y₂O₃. FIG. 3 shows a SAM 64 for a read/write head 58 that comprises a plurality of portions that can each have an ABS made from a different material. In one example, read/write head 58 includes a first portion, for example write pole 78, opposing first SAM 18 of magnetic recording composite 10, and a second portion, for example shield pole 80, opposing first SAM 18. The first portion 78 comprises a first material and the second portion 80 comprises a second material. Other portions of read/write head 58, such as shield 82, may also be included and may be made from the same material as either the first or second portions, or may be made from a third material. The plurality of molecules 66 that make up SAM 64 comprise a plurality of molecules 66A having head groups 68A that bond to the first material of the first portion 78 and a plurality of molecules 66B having head groups 68B that bond to the second material of the second portion 80. If the third portion 82 comprises a third material, than a third plurality of molecules 66C may be included with head groups 68C that bond to the third material. Multiple types of SAM molecules 66A, 66B, 66C with head groups 68A, 68B, 68C can be chosen to selectively bind to each separate material of these read/write head 58 components in order to form a uniform SAM 64 that performs as if it were bonded to a uniform surface.

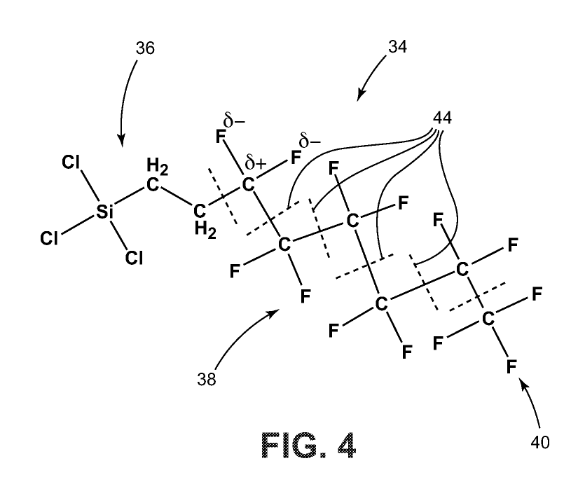

In one example, molecules 22 of SAM 18 are formed from precursor molecules, such as the example precursor molecule 34 shown in FIG. 4, that are deposited over outer surface 16 of magnetic recording composite 10 (described in more detail below). In one example, precursor molecules 34 are organic molecules, such as molecules having amphiphilic properties. Like the molecules 22 of SAM 18 they become, precursor molecules 34 may comprise a head group 36, a body group 38, and a tail group 40. Head group 36 of precursor molecules 34 may chemically react with outer surface 16 of magnetic recording composite 10 so that the resulting head group 24 of SAM molecules 22 is a modified version of precursor molecule head group 36. An example of this type of head group 36 is an alkyl group, such as —CH₃, that loses a hydrogen ion and bonds to outer surface 16 so that SAM molecule head group 24 is a —CH₂— group. Alternatively, head group 36 may be chemically removed from precursor molecule 34 and a portion of precursor molecule body group 38 reacts with outer surface 16 to form head group 24 of SAM molecules 22. An example of this type of head group is the —C₂H₄SiCl₃ end group on the precursor molecule (tridecafluoro-1,1,2,2-tetrahydrooctyl) tricholorsilane (also known as FOTS), shown in FIG. 4, that is knocked off during the deposition step resulting in a SAM molecule 22 comprising solely a chain of —(CF₂)ₙ—CF₃, where the first —CF₂— group bonded to outer surface 16 is head group 24 of SAM molecules 22. Precursor molecule body group 38 can either be the same as SAM body group 26, as is the case when precursor molecule head group 36 reacts directly with outer surface 16, or SAM body group 26 can be a modified version of precursor molecule body group 38, as is the case when precursor molecule head group 36 is removed and a portion of precursor molecule body group 38 bonds to outer surface 16 and becomes SAM head group 24. In one example, precursor molecule tail group 40 is the same as tail group 28 of the resulting SAM molecule 22. Examples of precursor molecules that may be acceptable to create SAM 18 include (tridecafluoro-1,1,2,2-tetrahydrooctyl) tricholorsilane (FOTS), perfluorohexadecanethiol (PFHDT), and heptadecafluoro-tetrahydrodecyl tricholorsilane (FDTS).

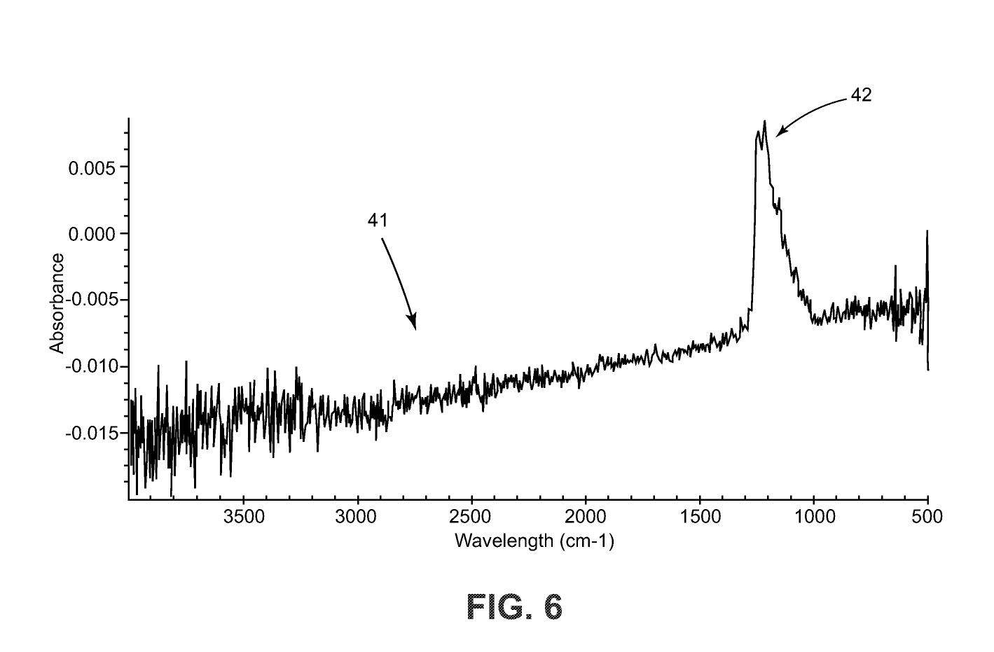

In one example, (tridecafluoro-1,1,2,2-tetrahydrooctyl) tricholosilane (FOTS) molecules 34, shown in FIG. 4, are used as precursor molecules to form SAM 18 on magnetic recording composite 10. FOTS molecules 34 form a Teflon-like coating on magnetic recording layer 14, which is supported by Fourier Transform Infra-Red (“FTIR”) spectrum 41 of the resulting SAM, shown in FIG. 6. The observed peak 42 in FTIR spectrum 41 corresponds to C—F vibration. No peaks corresponding to vibration of Si—Cl, C—H, or Si—C were detected, as shown in FIG. 6. The observation of only peak 42 for C—F vibration in FTIR spectrum 41 makes sense when the electronegativity associated with fluorine and carbon atoms are taken into account. The more electronegative fluorine atom may “pull” bonding electrons away from its neighboring carbon atom. This “pulling” of bonding electrons may make the fluorine atom partially negative (shown as “δ−” in FIG. 4) and may cause the neighboring carbon atom to become partially positive (shown as “δ+”). The redistribution of bonding electrons may contribute to the weakening of the C—C bond and favors bonding of the partially positive carbon atom with outer surface 16 of magnetic recording composite 10, which is rich in electron donors. The breakage of C—C bonds may occur at different sites along FOTS precursor molecule 34, indicated by dotted lines 44 in FIG. 4.

The general properties of recording composite SAM 18, particularly the properties of head groups 24, body groups 26 and tail groups 28, are very similar to the properties of other examples of SAMs described in this application, including a read/write head SAM 64 and alternative examples of recording composite SAM 18 and read/write head SAM 64 described below. Therefore, the preceding description of SAM 18 and head groups 24, body groups 26, and tail groups 28 also applies to these other SAMs 18, 64 and their respective head, body, and tail groups.

Returning to FIG. 1, in one example, SAM 18 is used as a protective and/or lubricating layer of magnetic recording composite 10 while a carbon protective layer, such as a diamond-like carbon (“DLC”) overcoat, adhered by an adhesion layer (not shown) protects the air bearing surface of read/write head 58 (shown in FIG. 3). SAM 18 may be designed to both protect and lubricate magnetic recording layer 14 without using additional layers, as shown in FIG. 1. In this example, SAM 18 replaces both a protective layer, such as a diamond-like carbon (“DLC”) overcoat, and a lubricant layer used to protect and lubricate magnetic recording layers. In order to provide for both protection and lubrication of magnetic recording composite 10, in one example, body group 26 and tail group 28 of SAM 18 provide for an outer surface 20 having low surface tension so that most contaminants will not be able to stick onto surface 20, or if they do stick, can be easily removed or dusted off. In addition, body group 26 and tail group 28 may have a high resistance to the heat and chemical. The low surface tension also increases the contact angle, so corrosive chemicals, contaminants, or particles will not stick to SAM surface 20. In one example, body group 26 and head group 28 comprise a backbone having the general formula of —(CF₂)ₙ—CF₃, wherein n is between about 2 and about 20, such as between about 4 and about 15, for example between about 4 and about 10.

SAM 18 may also be designed to act only as a lubricant, wherein SAM 18 is bonded to a separate protective layer (not shown) such as a DLC overcoat deposited over magnetic recording layer 14. In this way, a typical DLC overcoat remains and SAM 18 acts as a lubricant. In one example, body groups 26 and tail groups 28 provide lubrication by allowing for a low surface tension in order to reduce the contact area to a minimum. In one example, a fluorocarbon backbone having the general formula of —(CF₂)ₙ—CF₃ described above provides for this low surface tension. Finally, SAM 18 may only replace the DLC overcoat, and a lubricant may be deposited over SAM 18. In one example, if SAM 18 is providing the protection that is typically provided by a protective layer, such as a DLC overcoat, body groups 26 and head groups 28 may provide for resistance to high temperatures and chemical stability. In one example, a fluorocarbon backbone having the general formula of —(CF₂)ₙ—CF₃ described above provides for this property of SAM 18.

The thickness of a protective layer, such as a diamond-like carbon (“DLC”) overcoat, and lubricant layer, contributes to the head media separation (HMS), or the distance between the surface of the magnetic recording head and the surface of the magnetic recording layer of the storage composite. HMS can affect efficiency of data reading and writing such that thick protective overcoat and lubricant layers can greatly reduce the effective areal density, and hence storage capacity of the hard drive. Decreasing the thickness of some protective layers, such as DLC overcoats or lubricant layers, to increase areal density can adversely impact the performance of the protective layer. For example, when the combined thickness of a DLC overcoat and a lubricant layer is less than about 20 Å, there is a significant degradation in performance of these layers caused by imperfections such as pin holes or pore defects in the DLC overcoat. Maintaining a minimum protective overcoat thickness has become more of a concern by the recent use of energy-assisted magnetic recording (“EAMR”), such as heat-assisted magnetic recording (“HAMR”) or thermally-assisted magnetic recording (“TAMR”). The increased temperature associated with EAMR heightens thermally induced stress, resulting directly in failure of a protective overcoat that is too thin.

The various configurations of SAM 18, 64 shown in FIGS. 1, 3 and 5 as applied to magnetic recording composite 10 and read/write head 58 in disc drive 46 may provide sufficient protection against mechanical scratching, surface contamination, and corrosion of recording composite 10 or read/write head 58 while providing for very thin protective and lubricating layers. The thin SAMs 18, 64 allow for extremely close head-medium spacing (HMS) distance and a corresponding increase in recording efficiency. In one example, each SAM 18, 64 has a thickness of between about 5 angstroms and about 15 angstroms, such as between about 8 angstroms and about 12 angstroms, for example between about 9 angstroms and about 11 angstroms. In one example, wherein SAM 18 provides a protective layer and a lubricating layer for recording composite 10 and read/write head 58 includes a protective overcoat (not shown), the HMS distance is between about 2 angstroms and about 200 angstroms, such as between about 5 angstroms and about 120 angstroms, for example between about 10 angstroms and about 100 angstroms. In the example shown in FIG. 5, wherein SAM 18 provides a protective layer and a lubricating layer for recording composite 10 and SAM 64 provides a protective layer and lubricating layer for read/write head 58, the HMS distance may be between about 2 angstroms and about 200 angstroms, such as between about 5 angstroms and about 120 angstroms, for example between about 10 angstroms and about 100 angstroms.

The SAMs 18, 64 may be used to increase recording capacity. In one example, read/write head 58 is configured for energy-assisted magnetic recording (“EAMR”), such as via heat-assisted magnetic recording (“HAMR”), by including an optical transducer 84, shown in FIG. 3. Optical transducer 84 delivers a localized laser beam 86 that increases the temperature of outer surface 16 of magnetic recording composite 10 and read/write head ABS 62 to a predetermined temperature, typically between about 100° C. and about 400° C., but in some case to a temperature as high as 1000° C. The heating and cooling caused by such high temperatures causes thermally induced stress and localized protrusions in a DLC overcoat that can lead to damage or failure of the DLC overcoat. The high temperature associated with EAMR may also lead to the breakdown of lubricants. SAMs 18, 64 however, can be designed to be heat resistant to the higher temperatures required for EAMR. In one example, heat resistance is provided by a fluorocarbon backbone having the general formula of —(CF₂)ₙ—CF₃, as described above.

SAM 18 may be deposited over outer surface 16 of magnetic recording composite 10 by any one of several deposition methods including molecular layer deposition, chemical vapor deposition, solution immersion, dip coating, and combinations thereof. In one method, SAM precursor molecules in the gaseous state and magnetic recording composite 10 are placed in a vacuum chamber and a vacuum is applied so that the precursor molecules are physically absorbed onto outer surface 16. In one example method, the vacuum chamber has a pressure of about 1 Torr (about 133.32 Pa), a temperature of about 35° C., and magnetic recording composite 10 is placed in the vacuum chamber for a processing time of about 900 seconds (about 15 minutes). Magnetic recording composite 10 is then baked/annealed at a temperature sufficient to cause head groups 24 to bond to outer surface 16. In one example, this post-vacuum annealing comprises baking recording composite 10 at a temperature of about 100° C. for between about 20 minutes and about 30 minutes. Molecules 22 are then allowed to self assemble into SAM 18. A similar process could be used to deposit SAM 64 over read/write head 58 by placing precursor molecules in a gaseous state and read/write head 58 in a vacuum chamber, applying a vacuum so that the precursor molecules are absorbed onto ABS 62, baking read/write head 58 at a temperature sufficient to cause head groups 68 to bond to ABS 62 and allowing molecules 66 to self-assemble into SAM 64.

When multiple types of precursor molecules are used in order to form a uniform SAM 18 over magnetic recording layer 14 comprising several binding sites 76A, 76B, 76C comprising different materials, as described above with respect to FIG. 5, one method of depositing the SAM 18 includes placing a first type of precursor molecule in a vacuum chamber that bonds to first binding site 76A along with magnetic recording composite 10, wherein head groups 24A of the first precursor molecules have a chemical affinity for a first binding site 76A of magnetic recording layer 14, so that the first precursor molecules bond only to the material of the first binding site 76A; creating a vacuum within the vacuum chamber such that the first precursor molecules are physically absorbed onto outer surface 16 at first binding site 76A, and baking magnetic recording composite 10 at a temperature sufficient to cause head group 24A to bond to first material binding site 76A. Next a second type of precursor molecule is placed in the vacuum chamber, wherein head group 76B of the second precursor molecules have a chemical affinity for the material of a second binding site 76B of magnetic recording layer 14, so that the second precursor molecules bond only to the material of the second binding site 76B. The vacuum is then applied so that the second precursor molecules are absorbed on outer surface 16 at second binding site 76B, and magnetic recording composite 10 is then baked at a temperature sufficient to cause head group 24B to bond to second material binding site 76B. The process may then repeated with additional precursor molecules that have chemical affinities for the materials binding sites 76C and 76D, respectively.

In another example method, wherein multiple types of precursor molecules are used in order to form a uniform SAM 18 over magnetic recording layer 14 comprising several binding sites 76A, 76B, 76C, a first type of precursor molecule that bonds to first binding site 76A and a second type of precursor molecule that bonds to second binding site 76B are placed in a vacuum chamber at one time before applying a vacuum or bonding head groups 24A, 24B to binding sites 76A, 76B, such as by baking If additional types of precursor molecules are used to bond to other bonding sites, such as a third type of precursor molecule that bonds to a third bonding site 76C if it is different from the first and second precursor molecules, then the additional types of precursor molecules may also be placed in the vacuum chamber with the first and second types of precursor molecules before applying the vacuum or bonding the head groups. Next, a vacuum is applied and the precursor molecules are baked at a temperature sufficient to cause head groups 24A of the first type of precursor molecules to bond to first material binding site 76A, head groups 24B of the second type of precursor molecules to bond to second material binding site 78B, and head groups 24C of the third type of precursor molecules (if present) to bond to third material binding site 78C.

A similar method is used to form a uniform SAM 64 over ABS 62 of read/write head 58, wherein read/write head 58 comprises several portions made from difference materials, such as write pole 78, shield pole 80, and shield 82 described above with respect to FIG. 3. One method of depositing the SAM 64 includes placing a first type of precursor molecule in a vacuum chamber along with read/write head 58, wherein head group 68A of the first precursor molecules have a chemical affinity for the material of a first portion 78 of read/write head 58, so that the first precursor molecules bond only to the material of the first portion 78; creating a vacuum within the vacuum chamber such that the first precursor molecules are physically absorbed onto ABS 62 at first portion 78, and baking read/write head 58 at a temperature sufficient to cause head group 68A to bond to the material of first portion 78. Next a second type of precursor molecule is placed in the vacuum chamber, wherein head group 68B of the second precursor molecules has a chemical affinity for the material of a second portion 80 of read/write head 58, so that the second precursor molecules bond only to the material of the second portion 80. The vacuum is then applied so that the second precursor molecules are absorbed onto ABS 62 at second portion 80, and read/write head 58 is then baked at a temperature sufficient to cause head group 68B to bond to second component 80. The process may then repeated with additional precursor molecules that have chemical affinities for additional portions of read/write head 58.

In another example method, wherein multiple types of precursor molecules are used in order to form a uniform SAM 64 over read/write head 58 that comprises components made from a plurality of materials, a first type of precursor molecule that bonds to the material of a first portion of read/write head 58, such as write pole 78 made from a first material, and a second type of precursor molecule that bonds to a second portion of read/write head 58, such as shield pole 80 made from a second material, are placed in a vacuum chamber along with read/write head 58 at one time before applying a vacuum or bonding head groups 24A, 24B of the precursor molecules to read/write head 58, such as by baking. If additional types of precursor molecules are used to bond to other portions of read/write head 58, such as a third type of precursor molecule that bonds to a third portion, such as shield 82 made from a third material, then the additional types of precursor molecules may also be placed in the vacuum chamber with the first and second types of precursor molecules before applying the vacuum or bonding the head groups to read/write head 58. Next, a vacuum is applied and the precursor molecules are baked at a temperature sufficient to cause head groups 24A of the first type of precursor molecules to bond to the first material of the first portion 78, for head groups 24B of the second type of precursor molecules to bond to the second material of second portion 80, and for head groups 24C of the third type of precursor molecules (if present) to bond to the third material of third portion 82.

Various examples of the invention have been described. These and other examples are within the scope of the following claims.

1. A magnetic recording composite comprising:
a substrate;
a plurality of layers deposited over the substrate, the plurality of layers defining an outer surface; and
a self-assembled monolayer deposited over the outer surface of the plurality of layers, the self-assembled monolayer having an outer surface and comprising a plurality of molecules each having a head group bonded to the outer surface of the plurality of layers, a body group, and a tail group,
wherein the tail groups of the plurality of molecules form the outer surface of the self-assembled monolayer,
wherein the self-assembled monolayer forms a substantially continuous layer over the outer surface of the magnetic recording layer.

2. A magnetic recording composite according to claim 1, wherein each of the plurality of molecules of the self-assembled monolayer comprise an organic chain having between 2 and 20 carbon atoms.

3. A magnetic recording composite according to claim 1, wherein the plurality of molecules of the self-assembled monolayer orient at an angle of between about 0 degrees and about 45 degrees from the normal of the magnetic recording layer.

4. A magnetic recording composite according to claim 1, wherein the self-assembled monolayer has a thickness of between about 10 Å and 30 Å.

5. A magnetic recording composite according to claim 1, wherein the self-assembled monolayer further comprises cross-linking between at least some of the plurality of molecules.

6. A magnetic recording composite according to claim 1, wherein the plurality of layers comprises a magnetic recording layer.

7. A magnetic recording layer according to claim 6, wherein the self-assembled monolayer is deposited directly on the magnetic recording layer.

8. A magnetic recording composite according to claim 1, wherein the head group is selected from the group consisting of alkyl groups, halogenated alkyl groups, and alkylthiol groups.

9. A magnetic recording composite according to claim 1, wherein the body group is selected from the group consisting of alkyl-chain or perfluorinated alkyl backbone.

10. A magnetic recording composite according to claim 1, wherein the tail group comprises a hydrophobic group selected from the group consisting of alkyl end groups, halogenated alkyl end groups, and perfluoroalkyl group.

11. A magnetic recording composite according to claim 1, wherein the tail group comprises a hydrophilic group selected from the group consisting of hydroxyl groups, carboxyl groups, sulfuric group, sulfonate groups, and primary, secondary, and tertiary amines.

12. A magnetic recording composite according to claim 1, wherein the plurality of molecules are derived from precursor molecules selected from the group consisting of (tridecafluoro-1,1,2,2-tetrahydrooctyl) tricholorsilane (FOTS), perfluorohexadecanethiol (PFHDT), and heptadecafluoro-tetrahydrodecyl tricholorsilane (FDTS).

13. A magnetic recording composite according to claim 1, wherein the magnetic recording composite comprises a first binding site comprising a first material and a second binding site comprising a second material, wherein the plurality of molecules of the self-assembling monolayer comprise a plurality of first molecules having a first head group that bonds to the first material of the first binding site and a plurality of second molecules having a second head group that bonds to the second material of the second binding site.

14. A method of manufacturing magnetic recording media, the method comprising:
forming a self-assembled monolayer over an outer surface of a magnetic recording composite, the self-assembled monolayer having an outer surface,
wherein the self-assembled monolayer comprises a plurality of molecules each having a head group bonded to the magnetic recording layer, a body group, and a tail group, the tail groups of the plurality of molecules forming the outer surface of the self-assembled monolayer,
wherein the self assembled monolayer forms a substantially continuous layer over the outer surface of the magnetic recording composite.

15. A method according to claim 14, wherein forming the self-assembled monolayer comprises depositing a plurality of precursor molecules through vapor-phase deposition.

16. A method according to claim 15, wherein the plurality of precursor molecules are selected from the group consisting of (tridecafluoro-1,1,2,2-tetrahydrooctyl) tricholorsilane (FOTS), perfluorohexadecanethiol (PFHDT), and heptadecafluoro-tetrahydrodecyl tricholorsilane (FDTS).

17. A method according to claim 14, wherein the magnetic recording composite comprises a first binding site comprising a first material and a second binding site comprising a second material, wherein the plurality of molecules of the self-assembling monolayer comprise a plurality of first molecules having a first head group and a plurality of second molecules having a second head group, wherein forming the self-assembled monolayer comprises bonding the first head groups of the first molecules to the first material of the first bonding site and bonding the second head groups of the second molecules to the second material of the second binding site.

18. A device comprising:
a magnetic recording composite;
a first self-assembled monolayer having a first outer surface deposited over the magnetic recording composite;
a read/write head having a surface opposing the first outer surface; and
a second self-assembled monolayer having a second outer surface deposited over the surface of the read/write head;
wherein the first self-assembled monolayer comprises a plurality of first molecules each having a first head group bonded to the magnetic recording composite, a first body group, and a first tail group, wherein the first tail groups form the first outer surface of the first self-assembled monolayer, wherein the first self-assembled monolayer forms a substantially continuous layer over the magnetic recording composite, and wherein the second self-assembled monolayer comprises a plurality of second molecules each having a second head group bonded to the read/write head surface, a second body group, and a second tail group.

19. The device of claim 18, wherein the magnetic recording composite comprises a first binding site comprising a first material and a second binding site comprising a second material, wherein the plurality of first molecules comprise a plurality of third molecules having a third head group that bonds to the first material of the first binding site and a plurality of fourth molecules having a fourth head group that bonds to the second material of the second binding site.

20. The device of claim 18, wherein each of the plurality of first molecules comprise organic chains having between 2 and 20 carbon atoms.

21. The device of claim 18, wherein each of the plurality of second molecules comprise organic chains having between 2 and 20 carbon atoms.

22. The device of claim 18, wherein each of the plurality of first molecules orient at an angle of between about 0 degrees and about 45 degrees from the normal of an outer surface of the magnetic recording composite.

23. The device of claim 18, wherein each of the plurality of second molecules orient at an angle of between about 0 degrees and about 45 degrees from the normal of the surface of the read/write head.

24. The device of claim 18, wherein the second self-assembled monolayer has a thickness of between about 10 Å and about 30 Å.

25. The device of claim 18, wherein the second self-assembled monolayer further comprises cross-linking between at least some of the plurality of second molecules.

26. The device of claim 18, wherein the surface of the read/write head comprises a first portion opposing the first self-assembled monolayer and a second portion opposing the first self-assembled monolayer, the first portion comprising a first material and the second portion comprising a second material, wherein the plurality of second molecules of the second self-assembling monolayer comprise a plurality of third molecules having a third head group that bonds to the first material and a plurality of fourth molecules having a fourth head group that bonds to the second material.

27. The device of claim 18, wherein the first tail group is substantially the same as the second tail group.
